(19) United States
(12) Patent Application Publication
(10) Pub. No.: US 2007/0170168 A1
(43) Pub. Date: Jul. 26, 2007

(54) Color-coded cooktop and controls

(76) Inventor: Mitchell R. Moschetti, Fletcher, NC (US)

Correspondence Address: STEVEN C. SCHNEDLER;CARTER SCHNEDLER & MONTEITH, PA, 56 CENTRAL AVE., SUITE 101, PO BOX 2985, ASHEVILLE, NC, 28802, US

(21) Appl. No.: 11/787,407

(22) Filed: Apr. 13, 2007

(51) Int. Cl. H05B 3/68

(52) U.S. Cl. 219/445.1

(57) ABSTRACT

Cooktops employing a plurality of gas or electric heating units, and operatively-associated manually-operable controls. To indicate correspondence between heating units and control members, the heating units and manually-operable control members are color coded. Each heating unit and its corresponding control member is coded with the same color.

### BACKGROUND OF THE INVENTION

The invention relates to cooktops employing a plurality of gas or electric heating units, and associated manually-operable controls.

A variety of cooktop designs are known, typically employing heating units in the form of gas burners or electric heating units (including radiant and magnetic induction units under a glass-ceramic sheet), with an operatively-associated control member corresponding to each of the heating units. Some cooktops are part of a range also including an oven, in either a free-standing or a “drop in” configuration, while other cooktops are standalone units mounted within a countertop, separate from an oven.

Correspondence between heating units and control members is typically indicated to a user by small graphical representations of heating unit locations adjacent each control member; descriptions in words next to each control member, such as “left front” and “right rear;” lines drawn on a cooktop surface extending generally between each control member and its corresponding heating unit; physical locations of the control members; or combinations of these approaches.

### SUMMARY OF THE INVENTION

In one aspect, a cooktop including a plurality of heating units and a corresponding plurality of manually-operable control members is provided. Each of the manually-operable control members is operatively associated with a particular one of the heating units. The heating units and manually-operable control members are color coded, each heating unit and its corresponding control member being coded with the same color.

In another aspect, a method is provided for indicating correspondence between heating units and operatively-associated manually-operable control members in a cooktop of the type including a plurality of heating units and a corresponding plurality of manually-operable control members. The method comprises color-coding the heating units and manually-operable control members, each heating unit and its corresponding control member being coded with the same color.

In yet another aspect, a retrofit kit is provided for a cooktop of the type including a plurality of heating units and a corresponding plurality of manually-operable control members, wherein each of the manually-operable control members is operatively associated with a particular one of the heating units. The kit includes at least one heating unit indicia element of a color which is different from the standard color of the corresponding element of the cooktop as manufactured. The heating unit indicia element is adapted to be closely-associated with one of the heating units so as to color-code the heating units with at least two different colors. The kit further includes at least one control member indicia element of a color which is different from the standard color of the corresponding element of the cooktop as manufactured. The control member indicia element is adapted to be closely-associated with one of the manually-operable control members so as to color-code the control members, with each heating unit and its corresponding control member coded with the same color.

### BRIEF DESCRIPTION OF THE DRAWINGS

FIG. 1 is a three-dimensional view of a gas-burner cooktop embodying the invention, employing two different colors for color-coding;

FIG. 2 is a three-dimensional view of another gas-burner cooktop embodying the invention, employing four different colors for color-coding;

FIG. 3 is a three-dimensional view of yet another gas-burner cooktop embodying the invention, employing color-coded insets generally surrounding the gas burners flush with the gas burner grate;

FIG. 4 is a three-dimensional view of a cooktop with electric heating elements embodying the invention, with color-coded heating element center pieces and control knobs with correspondingly color-coded portions;

FIG. 5 is a three-dimensional view of a cooktop with electric heating elements embodying the invention, with color-coded heating element trim rings and correspondingly color-coded control knob trim rings;

FIG. 6 is a three-dimensional view of a glass-ceramic cooktop with radiant or magnetic electric heating units embodying the invention;

FIG. 7 is an enlarged view of a gas burner of the cooktop of FIG. 1, illustrating a gas burner with a cap that is solid in color;

FIG. 8 illustrates a gas burner with a cap having a colored center insert;

FIG. 9 illustrates a gas burner with a cap having a colored ring insert;

FIG. 10 is an enlarged view of one of the control knobs of the cooktop of FIG. 1, illustrating a basic solid-colored knob;

FIG. 11 illustrates a control knob with a color-coded inset strip;

FIG. 12 is an enlarged view of one of the control knobs of the cooktop of FIG. 5, illustrating a control knob with a color-coded trim ring;

FIG. 13 illustrates the cooktop of FIG. 4, with burner covers over the electric heating elements; and

FIG. 14 shows a retrofit kit for color-coding the heating units and control members of a cooktop.

### DETAILED DESCRIPTION

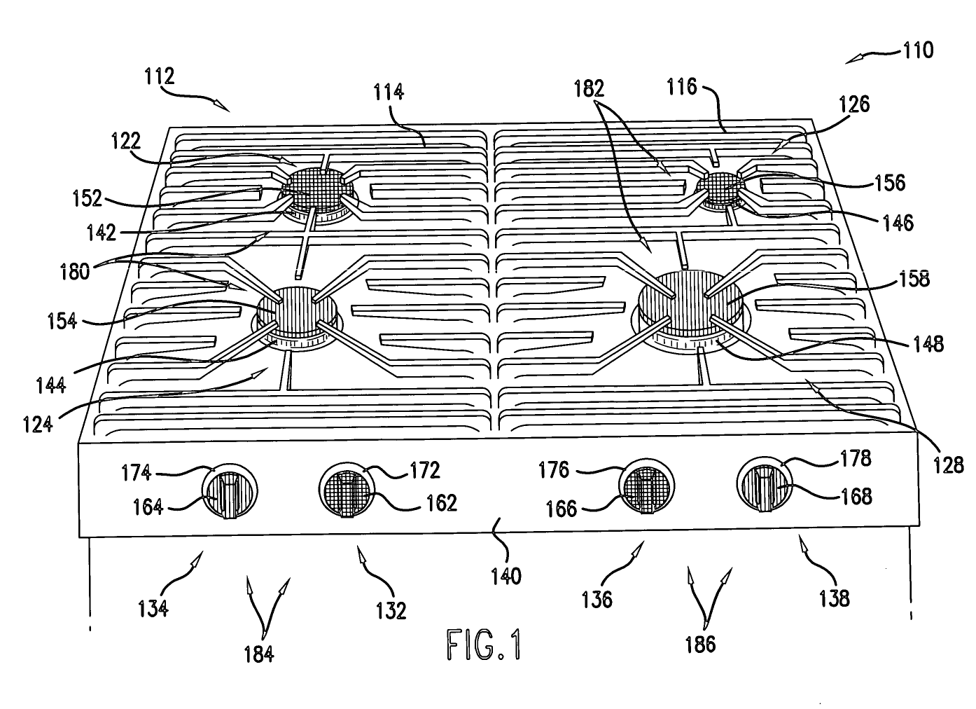

Referring first to FIG. 1, a cooktop 110 embodying the invention has a utensil-supporting grate 112 configured with individually removable left and right halves 114 and 116. The cooktop 110 includes four heating units 122, 124, 126 and 128 in the exemplary form of gas burners, left rear gas burner 122, left front gas burner 124, right rear gas burner 126, and right front gas burner 128; and four manually-operable control members 132, 134, 136 and 138 located on a front panel 140. The gas burners 122, 124, 126 and 128 are of different sizes. The right rear burner 126 is a relatively small “simmer” burner, while the right front burner 128 is a large burner. The left rear and left front burners 122 and 124 are of a medium size, and in some cooktop designs are different from each other.

In the gas burner embodiment of FIG. 1, the gas burners 122, 124, 126 and 128 include corresponding burner heads 142, 144, 146 and 148, and burner caps 152, 154, 156 and 158. The burner caps 152, 154, 156 and 158 form center pieces 152, 154, 156 and 158 of the corresponding gas burners 122, 124, 126 and 128. The control members 132, 134, 136 and 138 include individual knobs 162, 164, 166 and 168, and trim rings 172, 174, 176 and 178.

Each of the control members 132, 134, 136 and 138 is operatively associated with a corresponding particular one of the heating units 122, 124, 126 and 128. In the illustrated embodiment, the control knob 132 controls operation of the left rear gas burner 122; the control knob 134 controls operation of the left front gas burner 124; the control knob 136 controls operation of the right rear gas burner 126; and the control knob 138 controls operation of the right front gas burner 128.

The heating units have heating unit indicia elements which are provided in at least two different colors and closely associated with the heating units so as to color-code the heating units. Additionally the manually-operable control members have control member indicia elements which are provided in the same colors and closely associated with the manually-operable control members so as to correspondingly color-code the control members. In the embodiment of FIG. 1, the heating unit indicia elements comprise colored burner caps, and the illustrated burner caps 152, 154, 156 and 158 are lined to represent color. Thus, the burner cap 152 of the left rear gas burner 122 is yellow, the burner cap 154 of the left front gas burner 124 is red, the burner cap 156 of the right rear gas burner 126 is yellow, and the burner cap 158 of the right front gas burner 128 is red.

The control knobs 162, 164, 166 and 168 of the control members 132, 134, 136 and 138 are correspondingly color-coded, and in FIG. 1 are lined to represent color. Thus the control knob 162 of the control member of 132 which controls the left rear gas burner 122 is yellow, the control knob 164 of the control member 134 which controls the left front gas burner 124 is red, the control knob 166 of the control member 136 which controls the right rear gas burner 126 is yellow, and the control knob 168 of the control member 138 which controls the right front gas burner 128 is red.

As employed herein, the term “color” is intended to mean more than merely hue. Accordingly, it will be appreciated that variations in saturation and brightness of reflected light result in different colors, including such variations as may be imparted by different surface finishes, for example, surface finishes which may be characterized as “polished,” “brushed” and “matte.” Different materials may be employed to impart different colors, including different metals such as stainless steel, copper and brass. High-temperature plastics may also be employed, particularly in heating unit designs that avoid direct flame or heat. Moreover, as the term “color” is employed herein, black and white are both considered to be colors.

In the embodiment of FIG. 1, the heating units 122, 124, 126 and 128 are organized as heating unit pairs 180 (left) and 182 (right), and two different colors are employed. The first color is yellow, and gas burner 122 (left rear) of the first pair 180 and the gas burner 126 (right rear) of the second pair 182 are both coded yellow. The second color is red, and gas burner 124 (left front) of the first pair 180 is coded red, as well as gas burner 128 (right front) of the second pair 182. The manually-operable control members 132, 134, 136 and 138 are physically organized as pairs 184 (left) and 186 (right), control members 132 and 134 being in the control number pair 184 and control members 136 and 138 being in the control number pair 186. Each of the control number pairs 184 and 186 corresponds in physical location to a particular heating unit pair 180 or 182. In FIG. 1, two different colors are sufficient to avoid user hesitation or ambiguity regarding which control member controls which heating unit, even though there are four heating units 122, 124, 126 and 128.

It will be appreciated that the pair arrangement can be extended to cooktops having more than four heating units. Thus, a cooktop with six heating units (not shown) could include another pair of heating units and control members, also color-coded yellow and red. A cooktop with five heating units (not shown) could include a fifth heating unit in the center, as well as a fifth control member, both color-coded with a third color. Conversely, cooktops are available with only two heating units, in which case embodiments of the invention reduce to color-coding the heating units of a single pair.

The color-coding of the heating units 122, 124, 126 and 128 and the corresponding color-coding of the control members 132, 134, 136 and 138 thus provides a simple and unambiguous indication to a user of the associations between operatively-associated control members and heating units. As a particular example, such association is particularly helpful in the case of the gas burners 126 and 128 of the right side pair 182, where the center of the yellow-coded gas burner 126 (right rear) is to the right of the center of the red-coded gas burner 128, whereas the left and right positions of the corresponding control members 136 and 138 are reversed. Thus, in the absence of color-coding, in the particular cooktop 120 of FIG. 1, the user may be tempted to associate the rightmost control member 138 with the rightmost gas burner 126, which would be incorrect, and thereby inadvertently operate the wrong burner. Color-coding greatly minimizes the likelihood of such confusion.

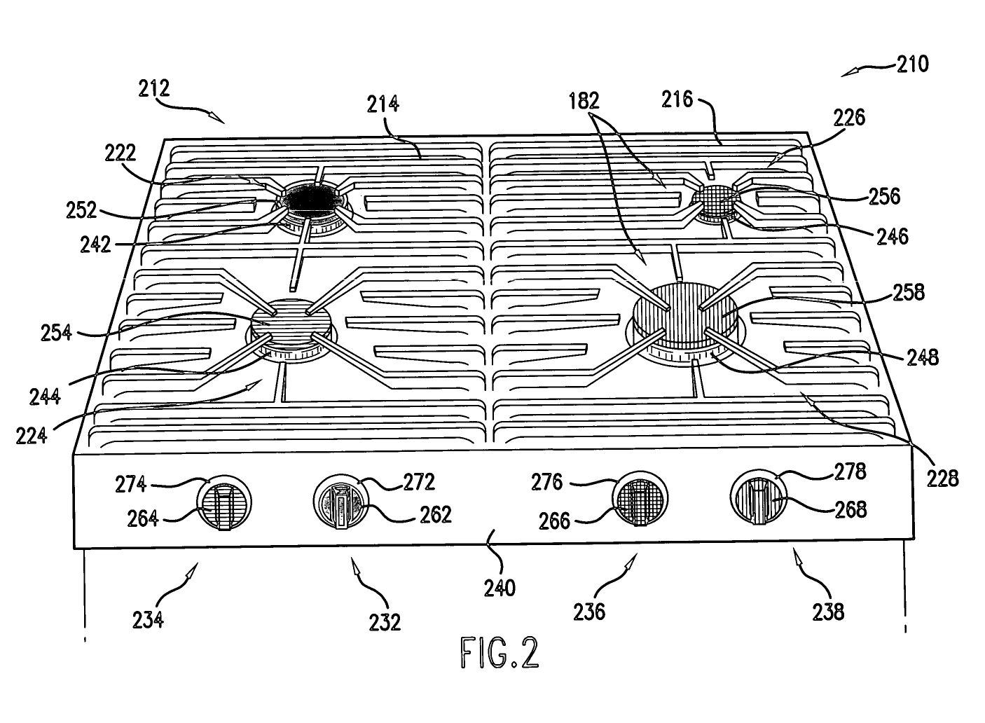

With reference now to FIG. 2, another cooktop 210 embodying the invention employs four different colors for color-coding. Other than the different color-coding, the cooktop 210 of FIG. 2 is essentially identical to the cooktop 110 of FIG. 1, and corresponding elements are designated by “200 series” reference numbers rather than by the “100 series” reference numbers employed hereinabove in the description of FIG. 1, and in general are not further described in detail herein. In FIG. 2, the burner caps 254, 256 and 258, and control knobs 264, 266 and 268 are lined to represent color, while burner cap 252 and control knob 262 are solid black.

In the embodiment of FIG. 2, in which four rather than two colors are employed for color-coding, the left rear gas burner 222 has a heating unit indicia element in the form of a burner cap 252 which is black in color; the left front gas burner 224 has a heating unit indicia element in the form of a burner cap 254 which is blue in color, the right rear gas burner 226 has a heating unit indicia element corresponding to a burner cap 256 which is yellow in color, and the right front gas burner 228 has a heating unit indicia element in the form of a burner cap 258 which is red in color. Correspondingly, the control knob 262 is black, the control knob 264 is blue, the control knob 266 is yellow, and the control knob 268 is red.

Again, the color-coding of the heating units 222, 224, 226 and 228 and the corresponding color-coding of the control members 232, 234, 236 and 238 provides a simple and unambiguous indication to a user of the associations between operatively-associated control members and heating units.

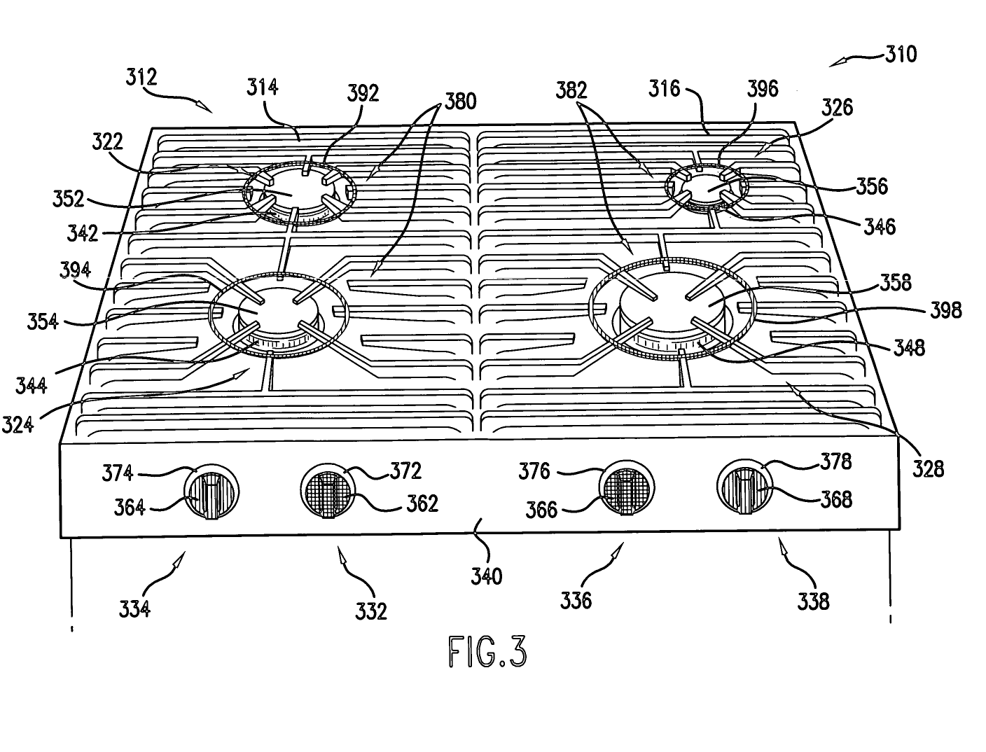

With reference now to FIG. 3, another cooktop 310 embodying the invention also employs color-coded heating units and control members. Elements of the FIG. 3 cooktop 310 are designated by “300 series” reference numbers and, in general, are essentially identical to corresponding elements of the FIG. 1 cooktop 110, and are not further described in detail herein. Elements of the FIG. 3 cooktop 310 which differ from those of the FIG. 1 cooktop 110 are referred to and described hereinbelow.

In the cooktop 310 of FIG. 3 the same two colors are employed as in the cooktop 110 of FIG. 1. The cooktop 310 of FIG. 3 differs from the cooktop 110 of FIG. 1 in the structure of the heating unit indicia elements. In FIG. 3, heating unit indicia elements 392, 394, 396 and 398 take the form of colored insets 392, 394, 396 and 398 surrounding the respective gas burners 322, 324, 326 and 328, and flush with the utensil-supporting grate 312. In FIG. 3, the insets 392, 394, 396 and 398 are lined to represent color. Left rear inset 392 is yellow, left front inset 394 is red, right rear inset 396 is yellow, and right front inset 398 is red.

In the embodiment of FIG. 3, the insets 392, 394, 396 and 398 are removable, and are set within notch-like recesses in the structure of the grate 312, which accordingly supports the colored insets 392, 394, 396 and 398. The insets 392, 394, 396 and 398 take the form of continuous rings. However, it will be appreciated that other shapes may be employed, such as square. Moreover, the insets 392, 394, 396 and 398 may be continuous or discontinuous.

In the cooktop 310 of FIG. 3, the burner caps 352, 354, 356 and 358 are all of the same color, since heating unit color-coding is provided by the inset rings 392, 394, 396 and 398.

Although the cooktop 310 of FIG. 3 employs two colors for color-coding, it will be appreciated that four colors may as well be employed, such as the four colors employed in the cooktop 210 of FIG. 2. Whether two or four colors are employed, color-coding of the heating units 322, 324, 326 and 328 employing the colored insets 392, 394, 396 and 398, and the corresponding color-coding of the control members 332, 334, 336 and 338, provides a simple and unambiguous indication to a user of the association between operatively-associated control members and heating units.

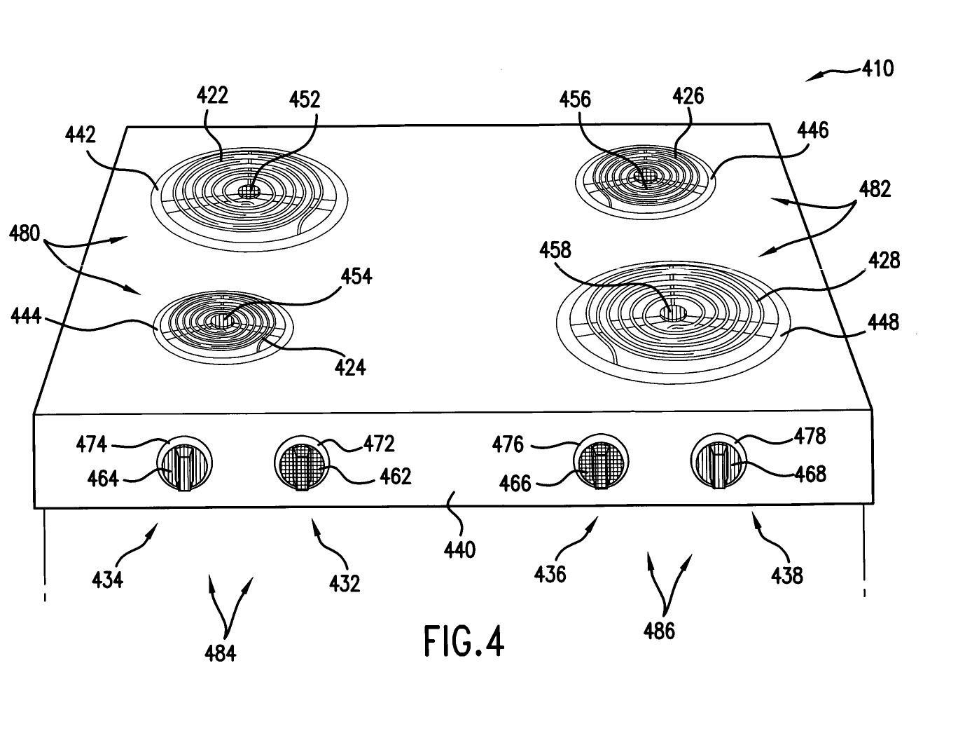

With reference now to FIG. 4, yet another cooktop 410 embodying the invention employs electric heating units 422, 424, 426 and 428, in the particular form of sheathed electrical resistance heating elements 422, 424, 426 and 428 each formed in a spiral. As in FIG. 1, there are four manually-operable control members 432, 434, 436 and 438 located on a front panel 440.

The electric heating units 422, 424, 426 and 428 have respective trim rings 442, 444, 446 and 448 surrounding the actual spiral heating element, as well as corresponding center pieces 452, 454, 456 and 458. The control members 432, 434, 436 and 438 include individual knobs 462, 464, 466 and 468, and trim rings 472, 474, 476 and 478.

Each of the control members 432, 434, 436 and 138 is associated with a corresponding particular one of the heating units 422, 424, 426 and 428. In the illustrated embodiment, the control member 432 controls operation of the left rear heating element 422; the control member 434 controls operation of the left front heating element 424; the control member 436 controls operation of the right rear heating element 426; and the control member 438 controls operation of the right front heating element 428.

The heating units have heating unit indicia elements provided in at least two different colors so as to color-code the heating units, and the manually-operable control members have control member indicia elements so as to correspondingly color-code the control members. In the embodiment of FIG. 4, the heating unit indicia elements comprise colored center pieces, and the illustrated center pieces 452, 454, 456 and 458 are lined to represent color. Thus, the center piece 452 of the left rear heating element 422 is yellow, the center piece 454 of the left front heating element 424 is red, the center piece 456 of the right rear heating element 426 is yellow, and the center piece 458 of the right front heating element 428 is red.

The control knobs 462, 464, 466 and 468 of the control members 432, 434, 436 and 438 are correspondingly color-coded, and in FIG. 4 are lined to represent color. Thus the control knob 462 of the control member of 432 which controls the left rear heating element 422 is yellow, the control knob 464 of the control member 434 which controls the left front heating element 424 is red, the control knob 466 of the control member 436 which controls the right rear heating element 426 is yellow, and the control knob 468 of the control member 438 which controls the right front heating element 428 is red.

As in FIG. 1, In the embodiment of FIG. 4, the heating units 422, 424, 426 and 428 are organized as heating unit pairs 480 (left) and 482 (right), and two different colors are employed. The first color is yellow, and heating element 422 (left rear) of the first pair 480 and the heating element 426 (right rear) of the second pair 482 are both coded yellow. The second color is red, and heating element 424 (left front) of the first pair 480 is coded red, as well as heating element 428 (right front) of the second pair 482. The manually-operable control members 432, 434, 436 and 438 are physically organized as pairs 484 (left) and 486 (right), control members 432 and 434 being in the control number pair 484 and control members 436 and 438 being in the control number pair 486. Each of the control number pairs 484 and 486 corresponds in physical location to a particular heating unit pair 480 or 482. Two different colors are sufficient to avoid user hesitation or ambiguity regarding which control member operates or controls which heating unit, even though there are four heating units 422, 424, 426 and 428.

Again, the color-coding of the heating units 422, 424, 426 and 428 and the corresponding color-coding of the control members 432, 434, 436 and 438 provides a simple and unambiguous indication to a user of the associations between operatively-associated control members and heating units.

With reference now to FIG. 5, another cooktop 510 embodying the invention also employs color-coded heating units and control members. Elements of the FIG. 5 cooktop 510 are designated by “500 series” reference numbers and, in general, are essentially identical to corresponding elements of the FIG. 4 cooktop 410, and are not further described in detail herein. Elements of the FIG. 5 cooktop 510 which differ from those of the FIG. 4 cooktop 410 are referred to and described hereinbelow.

In the cooktop 510 of FIG. 5, to provide another example, yellow and blue are employed for color-coding, rather than yellow and red. The cooktop 510 of FIG. 5 differs from the cooktop 410 of FIG. 4 in the form of the heating unit indicia elements, as well as in the form of the control member indicia elements.

In FIG. 5, heating unit indicia elements 542, 544, 546 and 548 take the form of colored trim rings 542, 544, 546 and 548 surrounding the respective heating elements 522, 524, 526 and 528, and the illustrated trim rings 542, 544, 546 and 548 are lined to represent color. Left rear trim ring 542 is yellow, left front trim ring 544 is blue, right rear trim ring 546 is yellow, and right front trim ring 548 is blue. The heating element center pieces 552, 554, 556 and 558 are all of the same color, since color-coding is provided by the trim rings 542, 544, 546 and 548. Control member indicia elements 572, 574, 576 and 578 take the form of color-coded trim rings 572, 574, 576 and 578 around control knobs 562, 564, 566 and 568, and the illustrated trim rings 572, 574, 576 and 578 are lined to represent color. Trim ring 572 is yellow, trim ring 574 is blue, trim ring 576 is yellow, and trim ring 578 is blue. The control knobs 562, 564, 566 and 568 are all of the same color, since color-coding is provided by the control member trim rings 572, 574, 576 and 578.

In the cooktop 510 of FIG. 5, the color-coding of the heating units 522, 524, 526 and 528 and the corresponding color-coding of the control members 532, 534, 536 and 538 provides a simple and unambiguous indication to a user of the associations between control members and heating units.

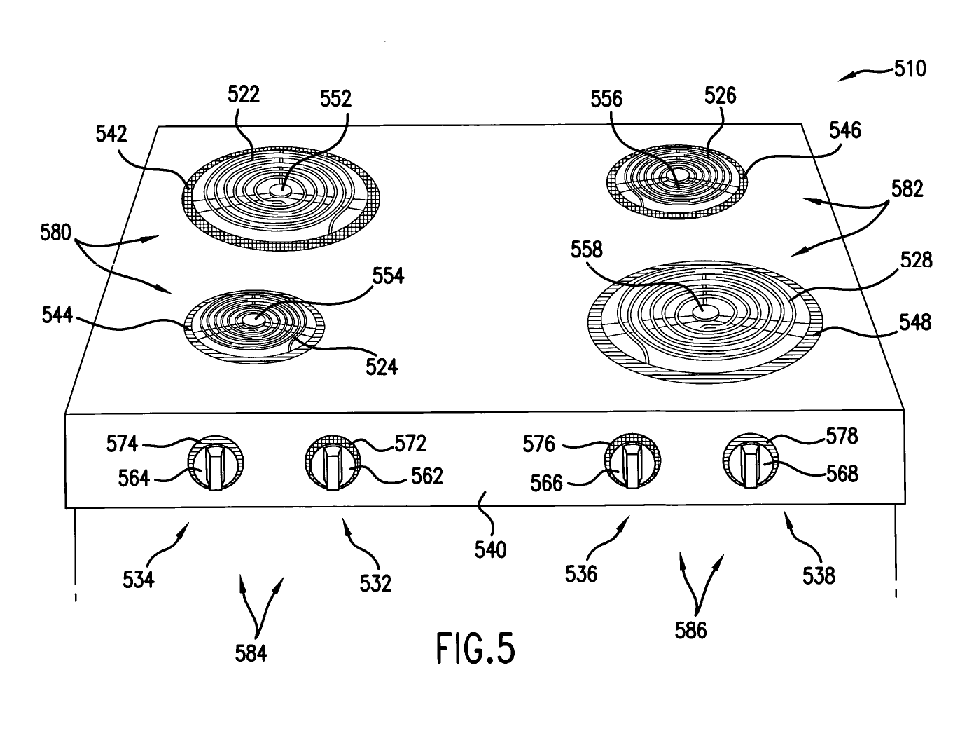

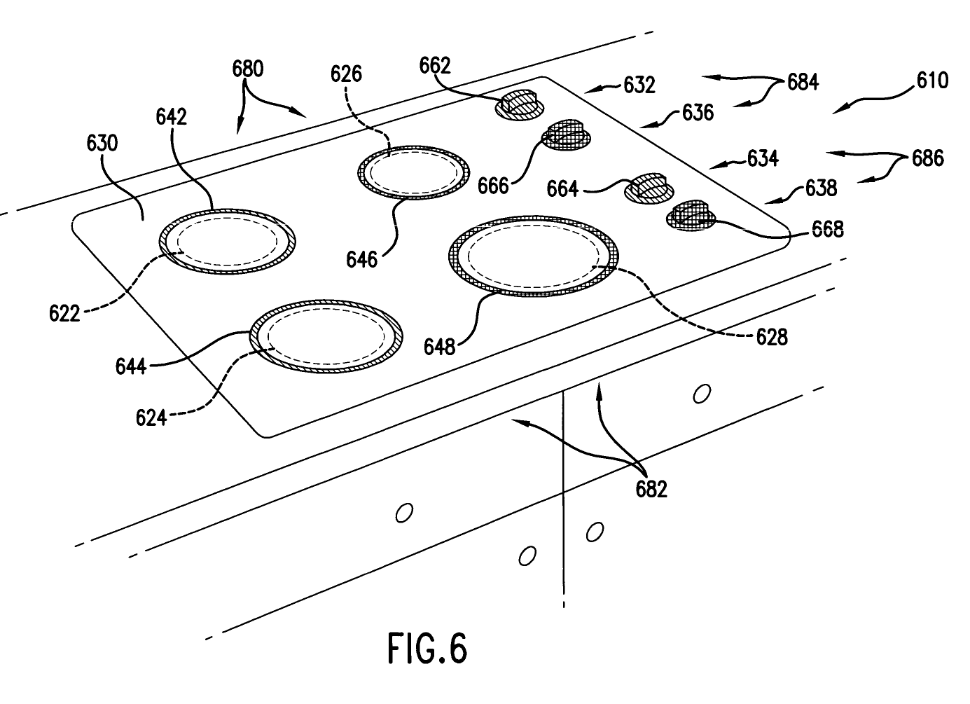

FIG. 6 illustrates a flat-surface glass-ceramic cooktop 610 embodying the invention. The cooktop 610 employs what are herein characterized as electric heating units 622, 624, 626 and 628 in the particular form of radiant or magnetic induction units 622, 624, 626 and 628 under a glass-ceramic sheet of material 630. The heating units may also be viewed as comprising defined regions of the glass-ceramic sheet 630. There are four manually-operable control members 632, 634, 636 and 638, located to the right of the heating units 622, 624, 626 and 628 on the glass-ceramic sheet 630 itself. The control members 632, 634, 636 and 638 may include portions extending through apertures (not shown) in the glass-ceramic sheet 630.

Each of the control members 632, 634, 636 and 138 is operatively associated with a corresponding particular one of the heating units 622, 624, 626 and 628. In the illustrated embodiment, the control member 632 controls operation of the left rear heating unit 622; the control member 634 controls operation of the left front heating unit 624; the control member 636 controls operation of the right rear heating unit 626; and the control member 638 controls operation of the right front heating unit 628.

Conventional glass-ceramic cooktops employ a variety of graphic designs to indicate the locations of the heating units, which would not otherwise be apparent due to the uniform nature of the surface of a glass-ceramic cooktop, particularly when a radiant heating unit under the glass-ceramic sheet is not energized. Heat-resistant glazes and enamels are used for this purpose. These graphic designs can be decorative and attractive, as a matter of industrial design.

The cooktop 610, by way of example, includes graphic designs 642, 644, 646 and 648 in the form of simple circles to indicate the locations of the heating units 622, 624, 626 and 628.

The heating units have heating unit indicia elements provided in at least two different colors so as to color-code the heating units, and the manually-operable control members have control member indicia elements so as to correspondingly color-code the control members. In the embodiment of FIG. 6, the heating unit indicia elements comprise colored graphic designs (circles in the illustrated embodiment) 642, 644, 646 and 648, and the illustrated graphic designs 642, 644, 646 and 648 are lined to represent color. Thus, the graphic design 642 indicating the position of the left rear heating element 622 is red, the graphic design 644 indicating the position of the left front heating element 624 is red, the graphic design 646 indicating the position of the right rear heating element 626 is yellow, and the graphic design 648 indicating the position of the right front heating element 628 is yellow.

The control members 632, 634, 636 and 638 include respective control knobs 662, 664, 666 and 668 which are correspondingly color-coded, and the illustrated control knobs 662, 664, 666 and 668 are lined to represent color. Thus the control knob 662 of the control member of 632 which controls the left rear heating element 622 is red, the control knob 664 of the control member 634 which controls the left front heating element 624 is red, the control knob 666 of the control member 636 which controls the right rear heating element 626 is yellow, and the control knob 668 of the control member 638 which controls the right front heating element 628 is yellow.

In the embodiment of FIG. 6, the heating units 622, 624, 626 and 628 are organized as heating unit pairs 680 (rear) and 682 (front), and two different colors are employed. The first color is red, and heating unit 622 (left rear) of the first pair 680 and the heating unit 624 (left front) of the second pair 682 are both coded red. The second color is yellow, and heating unit 626 (right rear) of the first pair 680 is coded yellow, as well as heating unit 628 (right front) of the second pair 682. The manually-operable control members 632, 634, 636 and 638 are physically organized as pairs 684 (rear) and 686 (front), control members 632 and 636 being in the control number pair 684 and control members 634 and 638 being in the control number pair 686. Each of the control member pairs 684 and 686 corresponds in physical location to a particular heating unit pair 680 or 682. Two different colors are sufficient to avoid user hesitation or ambiguity regarding which control member controls which heating unit, even though there are four heating units 622, 624, 626 and 628.

Again, the color-coding of the heating units 622, 624, 626 and 628 and the corresponding color-coding of the control members 632, 634, 636 and 638 provides a simple and unambiguous indication to a user of the associations between operatively-associated control members and heating units.

Particular combinations of heating unit indicia elements and control member indicia elements are illustrated and described hereinabove with reference to FIGS. 1-6. It will, however, be appreciated that indicia elements and combinations disclosed herein are by no means exhaustive, and a variety of others may be employed in embodiments of the invention. By way of example and not limitation, a cooktop may have individual relatively smaller gas burner grates which are color-coded. Various forms of colored tags may be employed. A large burner grate may have regions which are colored.

Mechanical control members are described in detail herein. The invention may also be embodied in flat-panel touch controls which are color-coded. Similarly, the indicia elements described in detail herein are all passive. However, active illumination, such as colored LEDs, or lamps with colored filters, may also be employed as indicia elements, for the heating units, control members, or both.

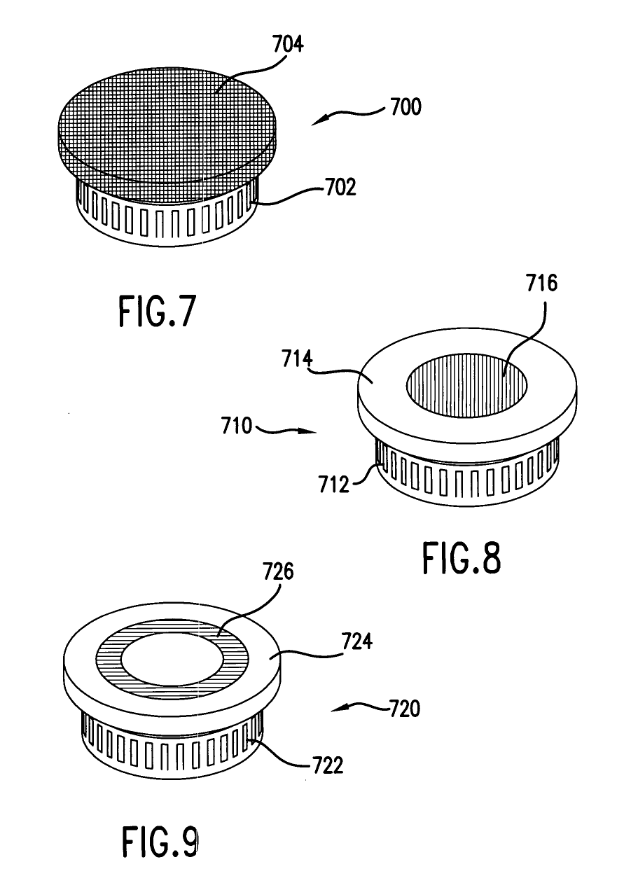

By way of further example, and not limitation, several forms of indicia elements are described next with reference to FIGS. 7-12.

FIG. 7, for purposes of comparison, illustrates a gas burner 700 which is essentially identical to the gas burner 122 of FIG. 1. The gas burner 700 includes a burner head 702, and a burner cap 704 which is color-coded yellow, to serve as a heating unit indicia element, and is lined in the illustration to represent yellow. The yellow color may be provided by a high-temperature enamel, a ceramic glaze over cast iron, anodizing, or any other suitable process.

FIG. 8 illustrates a gas burner 710 including a burner head 712 and a burner cap 714 including a colored circle insert 716, which serves as a heating unit indicia element. The circle shape of the insert 716 is an example only. The insert 716 can be any shape, such as square, triangular, etc. The insert 716, as an examples, is red. The colored insert 716 is formed in any suitable matter, either by coloring a portion of an otherwise integral burner head, or as a separate ceramic or metal part placed within a recess within the burner cap 714. The insert 716 may be made of ceramic, enameled metal, or be an anodized piece. Preferably, the insert 716 is small enough so that the same size insert may be employed in combination with burners of various sizes, including the smallest burner of a cooktop. The insert 716, by way of example, may be domed, flat, patterned, embossed, and the like.

With reference now to FIG. 9, a gas burner 720 includes a burner head 722 and a burner cap 724 including a ring insert 726 as the heating unit indicia element, which ring insert 726 is blue, and is lined in the illustration to represent blue. The circular “ring” 726 is an example only; insert 726 is not necessarily circular. The colored ring insert 726 likewise may be a colored portion on top of integral burner cap 724, or may be a separate piece within a recess formed on the burner cap 724. The colored ring insert 726 may be ceramic, enameled metal, anodized, or the like; and, by way of example, may be domed, flat, patterned, embossed, and the like.

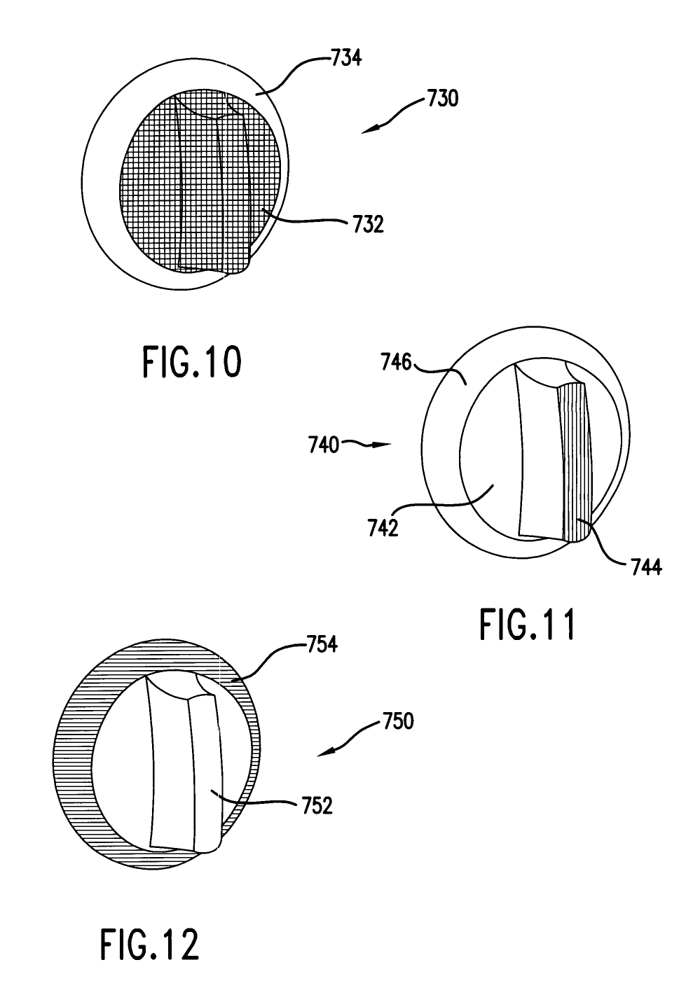

FIG. 10, for purposes of comparison, is an enlarged view of, for example, the control member 132 of FIG. 1. The FIG. 10 control member 730 includes a control knob 732 which is solid yellow and which serves as the control member indicia element, as well as a trim ring 734 which is not color-coded. In the illustration, the control knob 732 is lined to represent yellow.

FIG. 11 illustrates a control member 740 including a control knob 742 with a color-coded insert 744 which serves as the control member indica element. In the particular example of FIG. 11, the insert 744 is colored red, and in the illustration is lined to represent red. A plain trim ring 746 surrounds the control knob 744.

In FIG. 11, the insert 744 takes the form of an interchangeable insert strip, and the control knob 742 is configured to as to receive the insert strip which may, for example, be made of plastic.

FIG. 12 illustrates another embodiment of a control member 750, including a control knob 752 which is not color-coded. As a control member indicia element, a trim ring 754 or colored bezel 754 which is color-coded is provided. In FIG. 12 the trim ring is blue, and in the illustration is lined to represent blue.

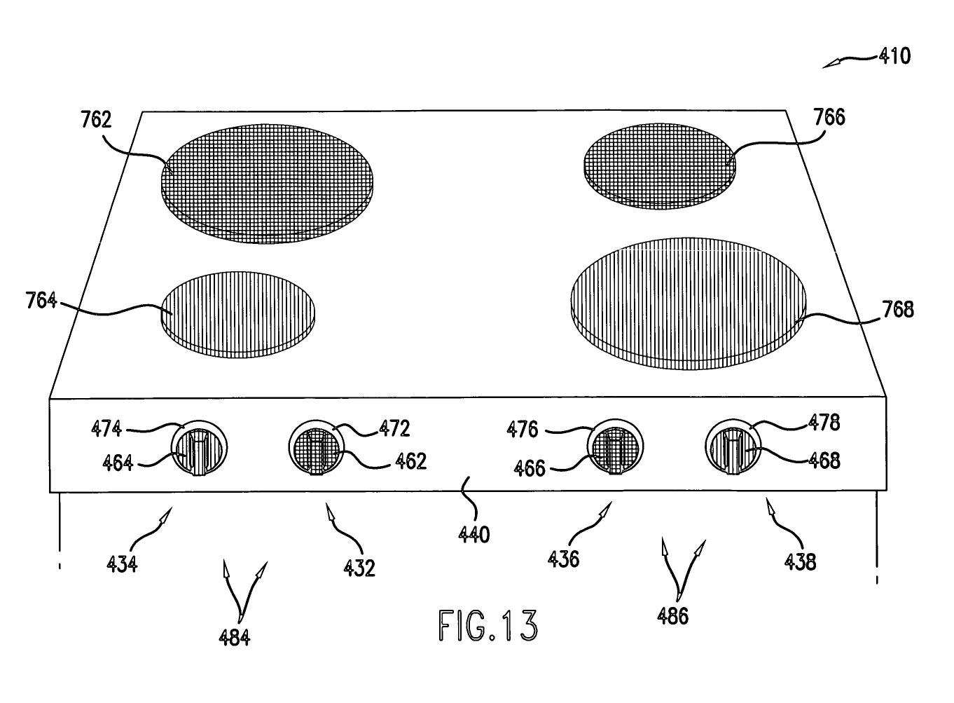

With reference to FIG. 13, the cooktop 412 of FIG. 4 is shown with color-coded decorative burner covers 762, 764, 766 and 768 over the electric heating units 422, 424, 426 and 428. The covers 762, 764, 766 and 768 in the illustration are lined to represent color. Left rear cover 762 is yellow, left front cover 764 is red, right rear cover 766 is yellow, and right front cover 768 is red. Such burner covers are sometimes employed over heating elements which are not in use to keep things from falling into cavities associated with heating elements, and for purposes of appearance. When the covers 762, 764, 766 and 768 are in place, the heating unit indicia elements 452, 454, 456 and 458 of FIG. 4 are hidden. Color-coding burner covers 762, 764, 766 and 768 is beneficial in avoiding inadvertently turning a heating element on which is covered. In general, the decorative covers 762, 764, 766 and 768 are not intended to withstand heat. Thus, it can be just as important to unambiguously identify which control member turns a particular heating unit on as it is to unambiguously identify which control member should not be actuated because the particular corresponding heating unit is covered.

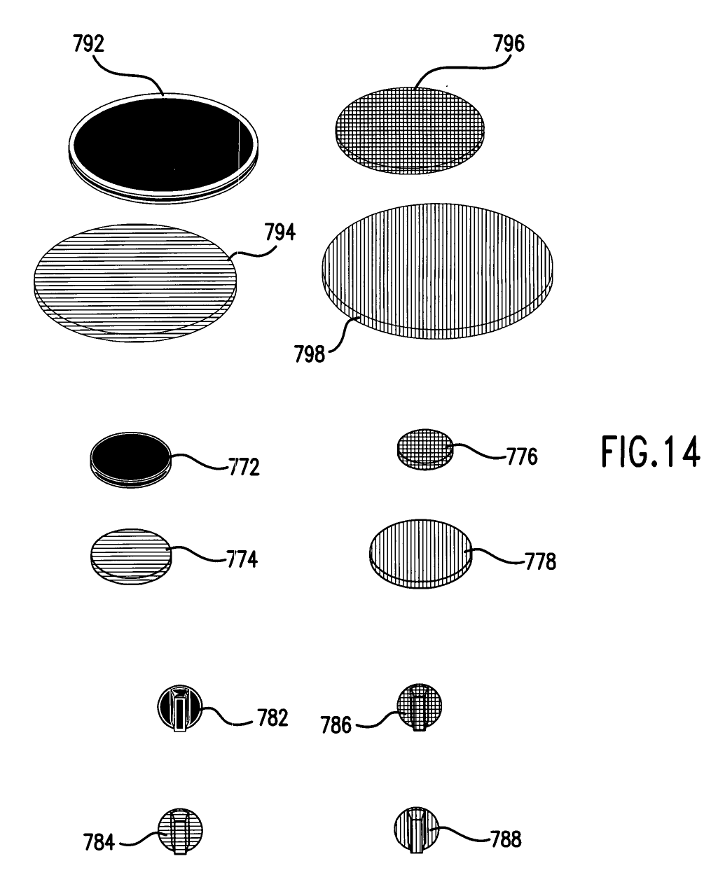

Embodiments of the invention have been described hereinabove in the context of complete cooktops, which are generally sold as a unit. With reference to FIG. 14, the invention may also be embodied in a retrofit kit, generally designated 770, including a plurality of heating unit indicia elements of at least two different colors, in the representative form of color-coded burner caps 772, 774, 776 and 778; and a corresponding plurality of control member indicia elements of at least two different colors, in the representative form of color-coded control knobs 782, 784, 786 and 788. In FIG. 14, the elements of the retrofit kit 770 are lined to represent color, or are solid black. Burner cap 772 and control knob 782 are black. Burner cap 774 and control knob 784 are blue. Burner cap 776 and control knob 786 are yellow. Burner cap 778 and control knob 788 are red. The parts of the retrofit kit 770 can thus be simply and easily applied to an existing cooktop. The retrofit kit 770 may also include color-coded decorative burner covers 792, 794, 796 and 798, when appropriate for the particular type or design of cooktop

In the case of a retrofit kit, although perhaps not preferred, it is sufficient to provide indicia elements in just one color, which is different than the manufacturer's color of those cooktop components which are to be color-coded. Thus, as one example, if a gas burner cooktop as manufactured has four heating units and employs burner caps and control knobs which are all black, for minimal color-coding purposes it is sufficient to provide two burner caps and two control knobs which are color-coded with a different color, such as white. Two of the manufacturer's black burner caps would remain, and two would be replaced to provide color-coding. A minimum retrofit kit, for a cooktop with just two heating units, includes just one heating unit indicia element of a color which is different from the standard color of the corresponding element of the cooktop as manufactured, and one control member indicia element of a color which is different from the standard color of the corresponding element of the cooktop as manufactured. What is important is that sufficient retrofit parts be included so that at least the heating units of each pair can be color-coded so as to distinguish between the two. A cooktop may have a single pair of heating units.

Although the disclosures hereinabove are in the context of cooktops, it will be appreciated that corresponding methods for color-coding the heating units and manually-operable control members of a cooktop so as to indicate correspondence between heating units and operatively-associated manually-operable control members have been disclosed.

While specific embodiments of the invention have been illustrated and described herein, it is realized that numerous modifications and changes will occur to those skilled in the art. It is therefore to be understood that the appended claims are intended to cover all such modifications and changes as follow in the true spirit and scope of the invention.

What is claimed is:

1. A cooktop comprising a plurality of heating units and a corresponding plurality of manually-operable control members, each of said manually-operable control members being operatively associated with a particular one of said heating units;
said heating units and said manually-operable control members being color coded, each heating unit and its corresponding control member being coded with the same color.

2. The cooktop of claim 1, wherein:
at least one of the said heating units has a closely-associated heating unit indicia element which is of a first color;
at least one other of said heating units has a closely-associated heating unit indicia element which is of a second color;
the manually-operable control member which is operably associated with said at least one of said heating units has a closely-associated control member indicia element which is of said first color; and
the manually-operable control member which is operably associated with said at least one other of said heating units has a closely-associated control member indicia element which is of said second color.

3. The cooktop of claim 2, which comprises;
a plurality of heating units organized as a plurality of heating unit pairs; wherein
within each heating unit pair, one of said heating units has a closely-associated heating unit indicia element which is of said first color, and the other one of said heating units has a closely-associated heating element which is of said second color; and wherein
said manually-operable control members are physically organized as pairs, and each pair of manually-operable control members visually corresponds in physical location to a particular heating unit pair.

4. The cooktop of claim 2, wherein each of said heating units has a closely-associated heating unit indicia element which is of a unique color.

5. The cooktop of claim 2, wherein said heating units comprise gas burners, and wherein each of said heating unit indicia elements comprises a gas burner cap with at least a portion which is colored.

6. The cooktop of claim 2, wherein said heating units comprise electric heating units, and wherein each of said heating unit indicia elements comprises a center piece of said electric heating unit.

7. The cooktop of claim 2, wherein said heating units comprise electric heating units, and wherein each of said heating unit indicia elements comprises a trim ring surrounding said electric heating element.

8. The cooktop of claim 2, wherein each of said control member indicia elements comprises a control knob with at least a portion which is colored.

9. The cooktop of claim 2, wherein each of said control member indicia elements comprises a control knob trim ring.

10. The cooktop of claim 1, which further comprises a plurality of color-coded heating unit decorative covers.

11. A method for indicating correspondence between heating units and operatively-associated manually-operable control members in a cooktop of the type including a plurality of heating units and a corresponding plurality of manually-operable control members, said method comprising color-coding the heating units and manually-operable control members, each heating unit and its corresponding control member being coded with the same color.

12. The method of claim 11, which comprises:
providing a plurality of heating unit indicia elements of at least two different colors, and closely associating each of the heating unit indicia elements with a particular one of the heating units so as to color-code the heating units; and
providing a corresponding plurality of control member indicia elements of the at least two different colors, and closely associating each of the control member indicia elements with a particular one of the manually-operable control members so as to color-code the control members, with each heating unit and its corresponding operatively-associated control member coded with the same color.

13. The method of claim 12, which comprises:
providing the plurality of heating unit indicia elements and the plurality of control member indicia elements in two different colors; and
color-coding the manually-operable control members and operatively-associated heating units in pairs, each pair of manually-operable control elements visually corresponding in physical location to a particular pair of heating units of the cooktop.

14. The method of claim 12, which comprises:
providing the plurality of heating unit indicia elements and the plurality of control member indicia elements in the same number of colors as there are heating units; and
color-coding each heating unit and its associated manually-operable control member with a unique color.

15. The method of claim 11, which further comprises providing a plurality of color-coded heating unit decorative covers.

16. A retrofit kit for a cooktop of the type including a plurality of heating units and a corresponding plurality of manually-operable control members, each of the manually-operable control members being operatively associated with a particular one of the heating units, said kit comprising:
at least one heating unit indicia element being of a color which is different from the standard color of the corresponding element of the cooktop as manufactured, said heating unit indicia element being adapted to be closely-associated with one of the heating units so as to color-code the heating units with at least two different colors; and
at least one control member indicia element of a color which is different from the standard color of the corresponding element of the cooktop as manufactured, said control member indicia element being adapted to be closely-associated with one of the manually-operable control members so as to color-code the control members, with each heating unit and its corresponding control member coded with the same color.

17. The kit of claim 16, wherein said heating unit indicia elements and said control member indicia elements are of two different colors, such that said manually-operable control members and associated heating units can be color-coded in pairs in a cooktop in which each pair of manually-operable control elements visually corresponds in physical location to a particular pair of heating units.

18. The kit of claim 16, wherein said heating unit indicia elements, and said control member indicia elements are of a plurality of colors such that each heating unit and its operatively-associated manually-operable control member can be color-coded with a unique color.

19. The kit of claim 16, which further comprises a plurality of color-coded heating unit decorative covers.
